(19) United States
(12) Patent Application Publication
(10) Pub. No.: US 2024/0260629 A1
(43) Pub. Date: Aug. 8, 2024

(54) ACIDIC LIQUID SEASONING

(71) Applicant: KEWPIE CORPORATION, Tokyo (JP)

(72) Inventors: Hiromitsu TAKAHASHI, Tokyo (JP); Haruka YAMAGUCHI, Tokyo (JP)

(73) Assignee: KEWPIE CORPORATION, Tokyo (JP)

(21) Appl. No.: 18/572,419

(22) PCT Filed: Jan. 11, 2022
(86) PCT No.: PCT/JP2022/000534

§ 371 Date: Dec. 20, 2023

(30) Foreign Application Priority Data
Jun. 23, 2021 (JP) 2021-104430

(51) Int. Cl. A23L 27/00; A23D 7/00; A23L 19/00; A23L 27/16

(52) U.S. Cl. CPC A23L 27/82; A23D 7/00; A23L 19/09; A23L 27/16

(57) ABSTRACT

To provide an acidic liquid seasoning where a sour taste with an aqueous phase and a delicious taste with an oil phase are well balanced and these are felt in a well-differentiated manner. The present invention provides a packaged acidic liquid seasoning containing at least edible oil and fat, edible vinegar, a plant ground product, thickening polysaccharide, and water, and at least partially having an emulsified phase, wherein a content of egg yolk is 0% by mass or more and 0.001% by mass or less, the edible oil and fat contain flavor oil and/or an oil-soluble flavoring agent, a content of the edible oil and fat is 15% by mass or more and 50% by mass or less based on the total amount of the acidic liquid seasoning, a content of acetic acid is 0.3% by mass or more and 0.8% by mass or less based on the total amount of the acidic liquid seasoning, a viscosity of the acidic liquid seasoning at 25° C. is 1500 mPa·s or more, and a half-value width of a mode size of oil droplets in the emulsified phase of the acidic liquid seasoning is 30.0 μm or more and 60.0 μm or less in a particle size distribution on a volume basis measured with a laser diffraction type particle size distribution measuring apparatus in analysis conditions: non-sphericity and refractive index 1.6, particle size measurement range: 0.021 μm or more and 2000 μm or less, and particle size scale: 132 ch.

### BACKGROUND OF THE INVENTION

### Field of the Invention

The present invention relates to an acidic liquid seasoning, and specifically relates to an acidic liquid seasoning containing a plant ground product and at least partially having an emulsified phase.

### Background Art

Conventionally, various acidic liquid seasonings including dressings have been eaten for flavoring to fresh vegetables, meat, and fresh fish. In particular, many acidic liquid seasonings have been produced and sold which have aqueous phases and oil phases by compounding of edible oil and fat and which include edible vinegar in aqueous phases.

There are here present as acidic liquid seasonings containing aqueous phases and oil phases, emulsified liquid seasonings in which emulsifiers are used to disperse oil phases in the form of oil droplets in aqueous phases, and separated liquid seasonings in which aqueous phases and oil phases are separated. Emulsified liquid seasonings are characterized by having a creamy flavor, and mayonnaise and the like are classified thereto. However, emulsified liquid seasonings, although wholly have a creamy flavor, tend to have a sour taste with aqueous phases and a flavor with oil phases, in which such sour taste and flavor are wholly averaged. For example, mayonnaise, although contains a large amount of edible vinegar, does not actually allow any sour taste of acetic acid to be directly strongly felt.

On the other hand, separated liquid seasonings are those which usually contain no emulsifiers and which are shaken immediately before eating and then have aqueous phases temporarily mixed with edible oil and fat, and such seasonings can allow a flavor with aqueous phases to be strongly felt. For example, there has been proposed a separated liquid seasoning including flavor oil placed on an aqueous phase portion in order to strengthen a spice taste (Patent Literature 1). However, such a separated liquid seasoning, while can allow flavors with an aqueous phase and an oil phase to be strongly felt, tend to exhibit a greasy flavor with oil and fat and cause richness of oil and fat having sharpness to be hardly felt.

### CITATION LIST

### Patent Literature

[Patent Literature 1] JP 2008-187976 A

### SUMMARY OF THE INVENTION

### Technical Problem

A problem of conventional acidic liquid seasonings has been that a flavor with an aqueous phase and a delicious taste with oil and fat (richness of oil and fat having sharpness and a flavor with an oil phase) are well balanced and no differentiated flavor can be realized. In particular, an acidic liquid seasoning containing a plant ground product has tended to have a taste wholly averaged, and has been remarkably problematic in differentiation.

The present invention has been made in view of the above problems, and provides an acidic liquid seasoning where a sour taste with an aqueous phase and a delicious taste with an oil phase are well balanced and these are felt in a well-differentiated manner.

### Solution to Problem

The present inventors have made intensive studies in order to solve the above problems, and as a result, have surprisingly found that the above problems can be solved by a packaged acidic liquid seasoning containing a plant ground product and at least partially having an emulsified phase, in which the half-value width of the mode size of oil droplets in the emulsified phase is regulated within a specified range. The present inventors have completed the present invention based on such findings.

In other words, according to one aspect of the present invention, there is provided

a packaged acidic liquid seasoning containing at least edible oil and fat, edible vinegar, a plant ground product, thickening polysaccharide, and water, and at least partially having an emulsified phase, wherein

a content of egg yolk is 0% by mass or more and 0.001% by mass or less,

the edible oil and fat contain flavor oil and/or an oil-soluble flavoring agent,

a content of the edible oil and fat is 15% by mass or more and 50% by mass or less based on the total amount of the acidic liquid seasoning,

a content of acetic acid is 0.3% by mass or more and 0.8% by mass or less based on the total amount of the acidic liquid seasoning,

a viscosity of the acidic liquid seasoning at 25° C. is 1500 mPa·s or more, and

a half-value width of a mode size of oil droplets in the emulsified phase of the acidic liquid seasoning is 30.0 μm or more and 60.0 μm or less in a particle size distribution on a volume basis measured with a laser diffraction type particle size distribution measuring apparatus in analysis conditions: non-sphericity and refractive index 1.6, particle size measurement range: 0.021 μm or more and 2000 μm or less, and particle size scale: 132 ch.

In an aspect of the present invention, the mode size of oil droplets in the emulsified phase of the acidic liquid seasoning is preferably 20 μm or more and 100 μm or less.

In an aspect of the present invention, the viscosity of the acidic liquid seasoning at 25° C. is preferably 20000 mPa·s or less.

In an aspect of the present invention, a content of the plant ground product in terms of dry weight is preferably 0.1% by mass or more and 40% by mass or less based on the total amount of the acidic liquid seasoning.

In an aspect of the present invention, the thickening polysaccharide is preferably gum.

In an aspect of the present invention, a content of the gum is preferably 0.01% by mass or more and 1.0% by mass or less based on the total amount of the acidic liquid seasoning.

In an aspect of the present invention, the gum preferably comprises at least one selected from the group consisting of xanthane gum, guar gum, tamarind seed gum, locust bean gum, gellan gum, and arabic gum.

In an aspect of the present invention, the gum preferably comprises xanthane gum.

In an aspect of the present invention, a content of the xanthane gum is preferably 0.01% by mass or more and 1.0% by mass or less based on the total amount of the acidic liquid seasoning.

In an aspect of the present invention, a plant material in the plant ground product preferably comprises sesame seeds.

In an aspect of the present invention, a plant material in the plant ground product preferably comprises an onion.

In an aspect of the present invention, the acidic liquid seasoning preferably further contains a plant ingredient.

In an aspect of the present invention, the plant ingredient is preferably the same plant material as that in the plant ground product.

### Advantageous Effects of Invention

According to the present invention, there can be provided an acidic liquid seasoning where a sour taste with an aqueous phase and a delicious taste with an oil phase are well balanced and these are felt in a well-differentiated manner. Such an acidic liquid seasoning can lead to a rise in consumer's appetite and further expansion of the acidic liquid seasoning market can be expected.

### BRIEF DESCRIPTION OF THE DRAWINGS

FIG. 1 is a graph representing the concepts of the mode size and the half-value width of oil droplets in a particle size distribution on a volume basis.

### DETAILED DESCRIPTION OF THE INVENTION

### <Acidic Liquid Seasoning>

The acidic liquid seasoning of the present invention contains at least a plant ground product, edible oil and fat, edible vinegar, thickening polysaccharide, and water, and may further contain a plant ingredient and other raw material.

The acidic liquid seasoning at least partially has an emulsified phase. In other words, the acidic liquid seasoning may be fully in an emulsified state, may be in a state where an oil phase partially floats on an upper portion, or may be in a state where an oil phase is layered on a portion which is in an emulsified state. The emulsified state here refers to a state where an oil phase is dispersed in the form of oil droplets in an aqueous phase (oil droplet-in-water type (O/W type)).

Examples of the acidic liquid seasoning include a dressing, a sauce, a mop sauce, and other foods similar thereto, and a dressing is preferable.

### (pH of Acidic Liquid Seasoning)

The pH of the acidic liquid seasoning is not particularly limited, and is, for example, preferably 3.0 or more and 4.6 or less, and the lower limit value is more preferably 3.3 or more, further preferably 3.6 or more and the upper limit value is more preferably 4.4 or less, further preferably 4.3 or less. When the pH of the acidic liquid seasoning is within the above range, not only the occurrence of microorganisms in the acidic liquid seasoning can be controlled to result in an increase in preservability, but also the balance between flavors of the acidic liquid seasoning can be improved. The value of the pH of the acidic liquid seasoning may be measured with a pH measuring instrument (desktop pH meter F-72 manufactured by Horiba Ltd.) at 1 atm and an initial temperature of 20° C.

### (Brix of Aqueous Phase of Acidic Liquid Seasoning)

The brix of the aqueous phase of the acidic liquid seasoning is, for example, preferably 4% or more, more preferably 8% or more, further preferably 10% or more at an initial temperature of 25° C. The total value of the content of the edible oil and fat (% by mass, based on the total amount of the acidic liquid seasoning) and the brix of the aqueous phase is, for example, preferably 15 or more, more preferably 20 or more, further preferably 25 or more.

The brix of the aqueous phase of the acidic liquid seasoning is a value measured with a refractometer at 1 atm and an initial temperature of 25° C.

### (Viscosity of Acidic Liquid Seasoning)

The viscosity of the acidic liquid seasoning is 1500 mPa·s or more, the lower limit value is preferably 1600 mPa·s or more, more preferably 1700 mPa·s or more, further preferably 1800 mPa·s or more, still more preferably 2000 mPa·s or more, most preferably 2500 mPa·s or more, and the upper limit value is preferably 20000 mPa·s or less, more preferably 15000 mPa·s or less, further preferably 10000 mPa·s or less, still more preferably 8000 mPa·s or less, most preferably 6000 mPa·s or less. A viscosity falling within the above range is preferably provided to the acidic liquid seasoning because a delicious taste of oil is easily felt. If the viscosity of the acidic liquid seasoning is less than the lower limit value, a delicious taste with the oil phase is not felt and the balance is deteriorated, furthermore a sour taste with the aqueous phase and a delicious taste with the oil phase are not differentiated, and thus the effects of the present invention are not obtained.

The method for measuring the viscosity is performed with a BH-type viscometer in conditions of an initial temperature of 25° C. and a number of rotations of 10 rpm, by use of rotor No. 3 at a viscosity of 1500 mPa·s or more and less than 10000 mPa·s, rotor No. 4 at a viscosity of 10000 mPa·s or more and less than 20000 mPa·s, rotor No. 5 at a viscosity of 20000 mPa·s or more and less than 40000 mPa·s, rotor No. 6 at a viscosity of 40000 mPa·s or more and less than 100000 mPa·s, or rotor No. 7 at a viscosity of 100000 mPa·s or more, and a value calculated with the reading after 3 minutes after initiation of the measurement is adopted.

### (Particle Size Distribution on Volume Basis)

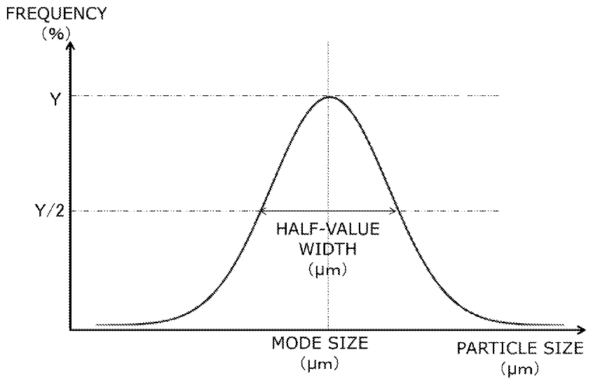

The width (μm) at a frequency half the frequency of the mode size of oil droplets in the emulsified phase of the acidic liquid seasoning (referred to as “half-value width”) is within a certain range in a particle size distribution on a volume basis measured with a laser diffraction type particle size distribution measuring apparatus in analysis conditions: non-sphericity and refractive index 1.6, particle size measurement range: 0.021 μm or more and 2000 μm or less, and particle size scale: 132 ch. The mode size here means a particle size (modal size) at the maximum frequency in the particle size distribution on a volume basis. The mode size and the half-value width of oil droplets, in the particle size distribution on a volume basis, are here described with reference to the graph in FIG. 1. In a case where the frequency of the mode size of oil droplets is Y (%), the width of the particle size at a frequency of Y/2(%) is the half-value width.

If two pieces of raw data corresponding to the modal size are present in one peak, the average value of such numerical values may be adopted as the mode size.

The frequency of particles in the present invention refers to a value representing the percentage of particles sorted into each particle size scale, relative to the total, in measurement at 0.021 μm or more and 2000 μm or less and a particle size scale of 132 ch.

The mode size of oil droplets in the emulsified phase of the acidic liquid seasoning is preferably 20 μm or more and 100 μm or less, and the lower limit value is more preferably 25 μm or more, further preferably 30 μm or more, still more preferably 35 μm or more and the upper limit value is more preferably 95 μm or less, further preferably 90 μm or less, still more preferably 80 μm or less, most preferably 70 μm or less. When the mode size of oil droplets in the emulsified phase of the acidic liquid seasoning is within the above range, a delicious taste with the oil phase is felt in a well-balanced manner and also a sour taste with the aqueous phase and a delicious taste with the oil phase are felt with being well differentiated. In the present invention, examples of the method for regulating the mode size of oil droplets include regulation of the intensity of stirring, regulation of the viscosity, or regulation of the amounts of compounding of edible oil and fat, thickening polysaccharide, and the like, in a production process of the acidic liquid seasoning.

The half-value width of the mode size of oil droplets in the emulsified phase of the acidic liquid seasoning is 30.0 μm or more and 60.0 μm or less, and the lower limit value is preferably 31.0 μm or more, more preferably 32.0 μm or more and the upper limit value is preferably 58.0 μm or less, more preferably 55.0 μm or less, further preferably 52.0 μm or less, still more preferably 50.0 μm or less. When the half-value width of the mode size of oil droplets is within the above range, a delicious taste with the oil phase is felt in a well-balanced manner and also a sour taste with the aqueous phase and a delicious taste with the oil phase are felt with being well differentiated. If the half-value width of the mode size of oil droplets is less than the lower limit value, the oil phase is so creamy that a sour taste with the aqueous phase and a delicious taste with the oil phase are not differentiated, and the effects of the present invention are not obtained. On the other hand, if the half-value width of the mode size of oil droplets is more than the upper limit value, a delicious taste with the oil phase is not felt and the balance is deteriorated, furthermore a sour taste with the aqueous phase and a delicious taste with the oil phase are not differentiated, and thus the effects of the present invention are not obtained. In the present invention, examples of the method for regulating the half-value width of the mode size of oil droplets include regulation of the intensity of stirring, regulation of the viscosity, or regulation of the amounts of compounding of edible oil and fat, thickening polysaccharide, and the like, in a production process of the acidic liquid seasoning.

The method for calculating the half-value width of the mode size of oil droplets in the emulsified phase of the acidic liquid seasoning can be made by, for example, reading from raw data. If there is no raw data matched with a frequency half the frequency at the mode size, a frequency is successively confirmed from the mode size, and a numerical value of a frequency which is first below a frequency half the frequency at the mode size is read. Specifically, in the case of raw data shown in Table 1 below, particle sizes of 67.86 μm and 37.00 μm, at which the frequency is first below 7.1% corresponding to half of 14.2% as a frequency at a mode size of 47.98 μm, are read, and the half-value width is calculated to be 30.86 μm.

TABLE 1

| Particle size scale (ch) | Particle size (μm) | Frequency (%) |
|---|---|---|
| 37 | 88.00 | 0.8 |
| 38 | 80.70 | 1.6 |
| 39 | 74.00 | 3.1 |
| 40 | 67.86 | 5.3 |
| 41 | 62.23 | 8.7 |
| 42 | 57.06 | 11.5 |
| 43 | 52.33 | 14.1 |
| 44 | 47.98 | 14.2 |
| 45 | 44.00 | 12.1 |
| 46 | 40.35 | 9.4 |
| 47 | 37.00 | 6.0 |
| 48 | 33.93 | 3.7 |

### (Method for Measuring Particle Size Distribution on Volume Basis)

The particle size distribution on a volume basis of oil droplets in the emulsified phase of the acidic liquid seasoning of the present invention is measured by the following procedure.

### (Measurement Procedure)

First, water in an amount 9 times is added to the emulsified phase of the acidic liquid seasoning of the present invention and these are well mixed, and measurement is performed in the following measurement conditions with a laser diffraction type particle size distribution measuring apparatus. In a case where a raw material which may have any effect on the measurement, such as an ingredient, is contained in the acidic liquid seasoning, such a raw material is removed in advance and then the measurement is performed.

### (Measurement Conditions)

Measuring instrument: laser diffraction type particle size distribution measuring apparatus (MicrotracMT3300EXII manufactured by Nikkiso Co., Ltd.)
Basis of measurement: volume
Analysis conditions: non-sphericity, refractive index 1.6
Particle size measurement range: 0.021 μm or more and 2000 μm or less
Particle size scale: 132 ch

### (Edible Oil and Fat)

The edible oil and fat for use in the acidic liquid seasoning conceptually encompass flavor oil and/or an oil-soluble flavoring agent, and edible oil and fat other than these can also be used.

The flavor oil refers to edible oil having a stronger spice taste than common oil, for example, oil to which a spice taste is imparted by roasting, virgin oil, or oil in which a spice taste component is extracted from a plant having a strong spice taste and transferred to the oil. Examples of the flavor oil include sesame oil, olive oil, garlic oil, onion oil, green onion oil, chili oil, roasted soybean oil, roasted rapeseed oil, basil oil, ginger oil, red pepper oil, black pepper oil, egg yolk oil, mustard oil, spice oil, and oleoresin. Such flavor oil may be used singly or in combination of two or more kinds thereof. In particular, sesame oil or olive oil is preferably used.

The content of the flavor oil is preferably 0.1% by mass or more and 30% by mass or less based on the total amount of the acidic liquid seasoning, and the lower limit value is more preferably 0.3% by mass or more, further preferably 0.5% by mass or more, still more preferably 0.8% by mass or more and the upper limit value is more preferably 28% by mass or less, further preferably 25% by mass or less, still more preferably 20% by mass or less.

The oil-soluble flavoring agent refers to, for example, an aroma component purified from a natural product or an aroma component artificially synthesized. Examples of the oil-soluble flavoring agent include citrus-based flavoring agents (lemon, grapefruit, yuzu orange, orange, and the like), fruit-based flavoring agents (banana, strawberry, apple, pineapple, and the like), milk-based flavoring agents (yogurt, butter, milk, and the like), mint-based flavoring agents, vegetable-based flavoring agents, vanilla-based flavoring agents, nut-based flavoring agents, and sesame seed-based flavoring agents. Such oil-soluble flavoring agents may be used singly or in combination of two or more kinds thereof. In particular, the oil-soluble flavoring agent here used is preferably an flavoring agent similar in kind to the plant ground product.

The content of the oil-soluble flavoring agent is preferably 0.01% by mass or more and 3.0% by mass or less based on the total amount of the acidic liquid seasoning, and the lower limit value is more preferably 0.03% by mass or more, further preferably 0.05% by mass or more, still more preferably 0.1% by mass or more and the upper limit value is more preferably 2.8% by mass or less, further preferably 2.5% by mass or less, still more preferably 2.0% by mass or less.

Such other edible oil and fat are not particularly limited and conventionally known edible oil and fat can be used. Examples of such other edible oil and fat can include vegetable oil and fat, such as rapeseed oil, soybean oil, palm oil, cotton seed oil, corn oil, sunflower oil, safflower oil, flaxseed oil, or rice oil, fish oil, beef tallow, lard, chicken fat, or MCT (medium-chain triglyceride), or oil and fat obtained by a chemical or enzymatic treatment, such as diglyceride, hardened oil or transesterified oil. In particular, vegetable oil and fat are preferably used, and rapeseed oil, soybean oil, corn oil, palm oil, or a mixed oil thereof is preferably used.

The content of the edible oil and fat is 15% by mass or more and 50% by mass or less based on the total amount of the acidic liquid seasoning, and the lower limit value is preferably 17% by mass or more, more preferably 20% by mass or more, further preferably 23% by mass or more and the upper limit value is preferably 45% by mass or less, more preferably 40% by mass or less, further preferably 35% by mass or less. A too low content of the edible oil and fat is not preferable because a delicious taste with oil and fat is hardly felt. A too high content of such oil and fat is not preferable because the half-value width of the mode size of oil droplets in the emulsified phase is difficult to regulate. Therefore, when the content of the edible oil and fat is within the above range, a delicious taste with oil and fat is easily felt and the half-value width of the mode size of oil droplets in the emulsified phase is easily regulated.

The total amount of the flavor oil and the oil-soluble flavoring agent is preferably 0.01 parts by mass or more and 80 parts by mass or less based on 100 parts by mass of the content of the edible oil and fat, and the lower limit value is more preferably 0.05 parts by mass or more, further preferably 0.1 parts by mass or more and the upper limit value is more preferably 70 parts by mass or less, further preferably 60 parts by mass or less, still more preferably 50 parts by mass or less.

### (Edible Vinegar)

The edible vinegar for use in the acidic liquid seasoning contains water and acetic acid as main components. Examples of the edible vinegar in the present invention include edible vinegar listed in “food labeling standards” prescribed by the Consumer Affairs Agency, and also a sour taste seasoning similar thereto. More specific examples of the edible vinegar include grain such as rice, malt, and sake lees, or processed products thereof, fruits such as grape and apple, vegetables such as onion, carrot, and tomato, other agriproducts, those obtained by acetic acid fermentation of alcohol or the like, those obtained by separate addition of acetic acid, or any mixture thereof. Such examples also include those obtained by addition of sugar, organic acid, amino acid, common salt, and/or the like. Examples of such edible vinegar include rice vinegar, black vinegar, grain vinegar, wine vinegar, apple cider vinegar, tomato vinegar, moromi vinegar, and plum vinegar. Such edible vinegar may be used singly or in combination of two or more kinds thereof.

The content of acetic acid is 0.3% by mass or more and 0.8% by mass or less based on the total amount of the acidic liquid seasoning, and the lower limit value is preferably 0.35% by mass or more, more preferably 0.4% by mass or more and the upper limit value is preferably 0.75% by mass or less, more preferably 0.7% by mass or less. A too low content of acetic acid is not preferable because a sour taste with the aqueous phase is hardly felt. A too high content of acetic acid is not preferable because a sour taste with the aqueous phase is too strong and the balance deteriorates. Therefore, when the content of acetic acid is within the above range, not only the occurrence of microorganisms in the acidic liquid seasoning is controlled to result in an increase in preservability, but also a favorable sour taste with the aqueous phase is felt and the balance is improved.

### (Plant Ground Product)

The plant ground product for use in the acidic liquid seasoning can be a plant material subjected to a grinding treatment. A plant material subjected to a grinding treatment in advance may be compounded in the acidic liquid seasoning, or a plant material may be mixed with other raw material and then the plant material may be subjected to a grinding treatment in a production process. The grinding treatment method is not particularly limited, and the treatment can be performed by an ordinary method with, for example, a millstone, a colloid mill, COMITROL, a food cutter, a milder, and a roll pulverizer. The shape and the size of the plant ground product are not particularly limited, and may be generally any shape and size which allow for easy compounding into a liquid seasoning.

The plant material of the plant ground product is not particularly limited, and examples thereof include plants such as sesame seeds, onion, green onion, garlic, daikon radish, ginger, myoga ginger, watercress, parsley, celery, Japanese basil, leek, Japanese honewort, basil, lemongrass, fennel, Japanese horse-radish, capsicum, pepper, mustard, lemon, apple, and paprika. Such plants may be used singly or in combination of two or more kinds thereof. Among these plants, sesame seeds or onion is preferably used. In particular, ground sesame seeds or grated onion is preferable.

The content of the plant ground product, in terms of dry weight, is preferably 0.1% by mass or more and 20% by mass or less based on the total amount of the acidic liquid seasoning, and the lower limit value is more preferably 0.2% by mass or more, further preferably 0.3% by mass or more, still more preferably 0.5% by mass or more and the upper limit value is more preferably 17% by mass or less, further preferably 15% by mass or less, still more preferably 10% by mass or less. The content of the plant ground product is preferably within the above range because a flavor of the plant material is felt.

### (Plant Ingredient)

The plant ingredient for use in the acidic liquid seasoning can be a plant material subjected to no grinding treatment. For example, the plant ingredient may be a plant material itself, or may be one which is obtained by a processing treatment such as slicing or cutting of a plant material and which is larger than that of the plant ground product.

The plant material exemplified with respect to the plant ground product can be used as the plant material of the plant ingredient. The plant material of the plant ingredient and the plant material of the plant ground product may be the same as or different from each other, and are preferably the same as each other in terms of flavor. The plant ingredient is preferably grain sesame seeds or cut onion.

The content of the plant ingredient, in terms of dry weight, is preferably 0.5% by mass or more and 40% by mass or less based on the total amount of the acidic liquid seasoning, and the lower limit value is more preferably 1.0% by mass or more, further preferably 2.0% by mass or more and the upper limit value is more preferably 30% by mass or less, further preferably 15% by mass or less, still more preferably 10% by mass or less. The content of the plant ingredient is preferably within the above range because a flavor of the plant material is felt.

### (Thickening Polysaccharide)

Examples of the thickening polysaccharide for use in the acidic liquid seasoning include gum and modified starch. Examples of the gum include xanthane gum, guar gum, tamarind seed gum, locust bean gum, gellan gum, and arabic gum. Such gum may be used singly or in combination of two or more kinds thereof. In particular, xanthane gum is preferably used.

The content of the gum is, for example, preferably 0.01% by mass or more and 1.0% by mass or less based on the total amount of the acidic liquid seasoning, and the lower limit value is more preferably 0.03% by mass or more, further preferably 0.05% by mass or more, still more preferably 0.10% by mass or more and the upper limit value is more preferably 0.70% by mass or less, further preferably 0.50% by mass or less, still more preferably 0.40% by mass or less, most preferably 0.30% by mass or less. In particular, the content of the xanthane gum is preferably within the above range. When the contents of the gum and the xanthane gum are within the above ranges, the emulsified state of the acidic liquid seasoning is easily kept and the half-value width of the mode size of oil droplets in the emulsified phase is easily regulated.

Examples of the modified starch include acetylated adipic acid crosslinked starch, acetylated phosphoric acid crosslinked starch, acetylated oxidized crosslinked starch, octenyl succinic acid starch, acetic acid starch, oxidized starch, hydroxypropyl starch, hydroxypropylated phosphoric acid crosslinked starch, phosphoric acid monoesterified phosphoric acid crosslinked starch, phosphoric acid crosslinked starch, and phosphorylated starch.

The content of the modified starch is, for example, preferably 0% by mass or more and 1.5% by mass or less based on the total amount of the acidic liquid seasoning, the upper limit value is more preferably 0.5% by mass or less, further preferably 0.3% by mass or less, still more preferably less than 0.1% by mass, and the modified starch is most preferably not substantially included. The reason for this is because, if modified starch having strong emulsification action, such as octenyl succinic acid starch, is contained in a certain or more amount, the half-value width of the mode size of oil droplets in the emulsified phase tends to be narrower and the half-value width is difficult to regulate.

### (Egg Yolk)

Examples of the egg yolk for use in the acidic liquid seasoning include liquid egg yolk and raw egg yolk, and such liquid egg yolk or raw egg yolk which is subjected to one, or two or more treatments of, for example, a sterilization treatment, a freezing treatment, a drying treatment such as spray dry or freeze dry, an enzyme treatment with phospholipase A1 or phospholipase A2, as in egg yolk treated with phospholipase A as described below, a desugaring treatment with yeast, glucose oxidase or the like, a decholesterolization treatment such as a supercritical carbon dioxide treatment, and a mixing treatment with common salt, a sugar content or the like.

The content of the egg yolk, in terms of raw one, is 0% by mass or more and 0.001% by mass or less based on the total amount of the acidic liquid seasoning, and the egg yolk is more preferably not substantially contained. The reason for this is because, if egg yolk having strong emulsification action is contained in a certain or more amount, the half-value width of the mode size of oil droplets in the emulsified phase tends to be narrower and the half-value width is difficult to regulate.

### (Other Raw Material)

The acidic liquid seasoning can contain various raw materials commonly used for liquid seasonings, which are appropriately selected, other than the above-mentioned raw materials, as long as the effects of the present invention are not impaired. Examples include seasonings such as soy sauce, sweet cooking rice wine, common salt, sodium glutamate, and bouillon, sugar such as granulated sugar, table sugar, glucose, fructose, sucrose, maltose, oligosaccharide, and trehalose, antioxidants such as ascorbic acid and vitamin E, and bacteriostatic agents.

### (Package)

The package to be filled with the acidic liquid seasoning is not particularly limited in terms of material, shape, and/or the like, and a package for conventionally known acidic liquid seasonings can be used. Examples of the package include respective hard packages made of plastic and glass, and respective soft packages made of polyethylene, polypropylene, and plastic. Examples of the shape of the package include a cylindrical shape and a bottle shape.

### <Method for Producing Packaged Acidic Liquid Seasoning>

One example of the method for producing the packaged acidic liquid seasoning of the present invention is described. For example, first, other raw materials of an aqueous phase, for example, the plant ground product, the edible vinegar, the thickening polysaccharide, freshwater, and a seasoning, are mixed to prepare the aqueous phase. Subsequently, while the aqueous phase prepared above is stirred by a mixer or the like, the edible oil and fat as raw materials of the oil phase are injected and emulsified, and thus the acidic liquid seasoning can be obtained.

Subsequently, the package is filled with the acidic liquid seasoning obtained, and thus the packaged acidic liquid seasoning can be produced. The oil phase may also be, if necessary, separately layered from above. The method for filling the acidic liquid seasoning with the package is not particularly limited, and such filling can be performed by a conventionally known.

### (Production Apparatus)

An apparatus for use in the production of a common acidic liquid seasoning can be used for production of the acidic liquid seasoning. Examples of such an apparatus include a common stirrer, a stick mixer, a stand mixer, and a homomixer. Examples of the form of a stirring blade of the stirrer include a propeller vane, a turbine vane, a paddle vane, and an anchor vane.

### EXAMPLES

Hereinafter, the present invention is further specifically described with reference to Examples and Comparative Examples, but the present invention is not interpreted to be limited to the contents of the following Examples.

### Production Example 1 of Acidic Liquid Seasoning

### Example 1

An acidic liquid seasoning was produced according to a compounding proportion described in Table 2. Specifically, edible vinegar (content of acetic acid 4%), a soy sauce, xanthane gum, common salt, granulated sugar, roasted black sesame seeds, ground black sesame seeds, and freshwater were loaded to a stirring tank and homogeneously mixed, and thus an aqueous phase was prepared. Thereafter, edible oil and fat (rapeseed oil and sesame oil) serving as an oil phase were injected to the aqueous phase prepared, an emulsification treatment was performed under stirring, and thus an acidic liquid seasoning having an emulsified phase was produced. Subsequently, a package was filled with the acidic liquid seasoning obtained, and thus a packaged acidic liquid seasoning was obtained.

### Examples 2 to 13 and Comparative Examples 1 to 12

Each acidic liquid seasoning was produced in the same manner as in Example 1 except that the compounding proportion was changed as described in Tables 2 and 3 and the intensity of stirring in the emulsification treatment was appropriately changed.

### (Measurement of pH)

The pH of each of the acidic liquid seasonings of Examples 1 to 13, obtained above, was measured with a pH measuring instrument (desktop pH meter F-72 manufactured by Horiba Ltd.) at 1 atm and an initial temperature of 20° C. The pH of each of the acidic liquid seasonings was 3.6 or more and 4.3 or less.

### (Measurement of Brix)

The brix of the aqueous phase of each of the acidic liquid seasonings of Examples 1 to 13, obtained above, was measured with a digital refractometer (digital refractometer RX-5000a manufactured by ATAGO CO., LTD.) at an initial temperature of 25° C. The brix of the aqueous phase of each of the acidic liquid seasonings was 10% or more. The total value of the content of the edible oil and fat (% by mass, based on the total amount of each of the acidic liquid seasonings) and the brix of the aqueous phase was 25 or more.

### (Measurement of Viscosity)

The viscosity of each of the acidic liquid seasonings obtained above was determined by measurement with a BH-type viscometer in conditions of an initial temperature of 25° C. and a number of rotations of 10 rpm, by use of rotor No. 3 at a viscosity of less than 10000 mPa·s, rotor No. 4 at a viscosity of 10000 mPa·s or more and less than 20000 mPa·s, rotor No. 5 at a viscosity of 20000 mPa·s or more and less than 40000 mPa·s, rotor No. 6 at a viscosity of 40000 mPa·s or more and less than 100000 mPa·s, or rotor No. 7 at a viscosity of 100000 mPa·s or more, and calculation from the reading after 3 minutes after initiation of the measurement. The measurement results were shown in Tables 2 and 3.

### (Measurement of Particle Size Distribution on Volume Basis)

The particle size distribution on a volume basis of oil droplets in the emulsified phase of each of the acidic liquid seasonings obtained above was measured with the following measurement procedure and measurement conditions, and the mode size and the half-value width were calculated. The measurement results were shown in Tables 2 and 3.

### (Measurement Procedure)

First, water in an amount of 9 times is added to the emulsified phase of each of the acidic liquid seasonings and these are well mixed, and measurement is performed in the following measurement conditions with a laser diffraction type particle size distribution measuring apparatus. In a case where a raw material which may have any effect on the measurement, such as an ingredient, is contained in the acidic liquid seasoning, such a raw material is removed in advance and then the measurement is performed.

### (Measurement Conditions)

Measuring instrument: laser diffraction type particle size distribution measuring apparatus (MicrotracMT3300EXII manufactured by Nikkiso Co., Ltd.)
Basis of measurement: volume
Analysis conditions: non-sphericity and refractive index 1.6
Particle size measurement range: 0.021 μm or more and 2000 μm or less
Particle size scale: 132 ch

### (Sensory Evaluation)

Each of the acidic liquid seasonings obtained above was subjected to sensory evaluation of a sour taste with the aqueous phase (acetic acid-derived sour taste) and a delicious taste with the oil phase (richness of oil having sharpness and flavors of flavor oil and an flavoring agent) by a plurality of sufficiently trained panelists having three or more years of experience of seasoning development, according to the following criteria. The results were shown in Tables 2 and 3. A score of 2 points or more can be said to mean a favorable result.

### <Evaluation Criteria>

4: the balance between a sour taste with the aqueous phase and a delicious taste with the oil phase was optimal, and these could be felt in an extremely well-differentiated manner.
3: a sour taste with the aqueous phase and a delicious taste with the oil phase were well balanced and these could be felt in a well-differentiated manner.
2: a sour taste with the aqueous phase was slightly strong or slightly weak, or a delicious taste with oil was slightly strong or slightly weak, whereas the balance between a sour taste with the aqueous phase and a delicious taste with the oil phase, and differentiation between these tastes had no problems.
1: a sour taste with the aqueous phase was not felt or was too strong or a delicious taste with the oil phase was not felt and the balance between a sour taste with the aqueous phase and a delicious taste with the oil phase was inferior, or a sour taste with the aqueous phase and a delicious taste with the oil phase were not differentiated.

In each of the acidic liquid seasonings of Examples 1 to 13, a sour taste with the aqueous phase and a delicious taste with the oil phase were well balanced and these could be felt in a well-differentiated manner.

In each of the acidic liquid seasonings of Comparative Examples 1 and 2, the half-value width of the mode size of oil droplets in the emulsified phase was small and thus the oil phase was so creamy that a sour taste with the aqueous phase and a delicious taste with the oil phase were not differentiated.

In each of the acidic liquid seasonings of Comparative Examples 3 and 4, the viscosity was low, thus a delicious taste with the oil phase was not felt and the balance was inferior, and a sour taste with the aqueous phase and a delicious taste with the oil phase were not differentiated.

In each of the acidic liquid seasonings of Comparative Examples 5 and 6, the half-value width of the mode size of oil droplets in the emulsified phase was large, thus a delicious taste with the oil phase was not felt and the balance was inferior, and a sour taste with the aqueous phase and a delicious taste with the oil phase were not differentiated.

In the acidic liquid seasoning of Comparative Example 7, the half-value width of the mode size of oil droplets in the emulsified phase was small and thus the oil phase was so creamy that a sour taste with the aqueous phase and a delicious taste with the oil phase were not differentiated.

In each of the acidic liquid seasonings of Comparative Examples 8 and 9, the content of acetic acid was high, and thus a sour taste with the aqueous phase was so strong that the balance was inferior.

In each of the acidic liquid seasonings of Comparative Examples 10 and 11, the content of acetic acid was low, thus a sour taste with the aqueous phase was not felt and the balance was inferior, and a sour taste with the aqueous phase and a delicious taste with the oil phase were not differentiated.

In the acidic liquid seasoning of Comparative Example 12, the half-value width of the mode size of oil droplets in the emulsified phase was large, thus a delicious taste with the oil phase was not felt and the balance was inferior, and a sour taste with the aqueous phase and a delicious taste with the oil phase were not differentiated.

TABLE 2

| | | | | Co. | Co. | Co. | Co. | Co. | |
|---|---|---|---|---|---|---|---|---|---|
| | | Ex. | Ex. | Ex. | Ex. | Ex. | Ex. | Ex. | Ex. |
| Raw material | | 1 | 2 | 1 | 2 | 3 | 4 | 5 | 3 |
| Oil | Rapeseed | 31 | 31 | 31 | 31 | 10 | 10 | 45 | 45 |
| phase | oil | | | | | | | | |
| | Sesame | 2 | 2 | 2 | 2 | 2 | 2 | 2 | 2 |
| | oil | | | | | | | | |
| | Sesame | 0 | 0 | 0 | 0 | 0 | 0 | 0 | 0 |
| | flavoring | | | | | | | | |
| | agent | | | | | | | | |
| Aqueous | Edible | 13 | 13 | 13 | 13 | 13 | 13 | 13 | 13 |
| phase | vinegar | | | | | | | | |
| | Soy | 4 | 4 | 4 | 4 | 4 | 4 | 4 | 4 |
| | sauce | | | | | | | | |
| | Xanthane | 0.15 | 0.15 | 0.15 | 0.15 | 0.05 | 0.05 | 0.05 | 0.05 |
| | gum | | | | | | | | |
| | Common | 3 | 3 | 3 | 3 | 3 | 3 | 3 | 3 |
| | salt | | | | | | | | |
| | Granulated | 15 | 15 | 15 | 15 | 15 | 15 | 15 | 15 |
| | sugar | | | | | | | | |
| | Roasted | 3 | 3 | 3 | 3 | 3 | 3 | 3 | 3 |
| | black | | | | | | | | |
| | sesame | | | | | | | | |
| | seeds | | | | | | | | |
| | (dry | | | | | | | | |
| | weight) | | | | | | | | |
| | Ground | 6.5 | 6.5 | 6.5 | 6.5 | 6.5 | 6.5 | 6.5 | 6.5 |
| | black | | | | | | | | |
| | sesame | | | | | | | | |
| | seeds | | | | | | | | |
| | (dry | | | | | | | | |
| | weight) | | | | | | | | |
| | Modified | 0 | 0 | 0.2 | 0 | 0 | 0 | 0 | 0 |
| | starch | | | | | | | | |
| | (octenyl | | | | | | | | |
| | succinic | | | | | | | | |
| | acid | | | | | | | | |
| | starch | | | | | | | | |
| | sodium) | | | | | | | | |
| | Egg | 0 | 0 | 0 | 0.2 | 0 | 0 | 0 | 0 |
| | yolk | | | | | | | | |
| | Fresh- | Bal- | Bal- | Bal- | Bal- | Bal- | Bal- | Bal- | Bal- |
| | water | ance | ance | ance | ance | ance | ance | ance | ance |

| | | | | | | | | |
|---|---|---|---|---|---|---|---|---|
| Total (% by mass) | 100 | 100 | 100 | 100 | 100 | 100 | 100 | 100 |
| Content of acetic acid | 0.52 | 0.52 | 0.52 | 0.52 | 0.52 | 0.52 | 0.52 | 0.52 |
| (% by mass) | | | | | | | | |
| Content of edible oil | 33 | 33 | 33 | 33 | 12 | 12 | 47 | 47 |
| and fat (% by mass) | | | | | | | | |
| Viscosity (mPa · s) | 2700 | 2700 | 4000 | 4100 | 200 | 200 | 2500 | 2500 |
| Mode size (μm) | 62.23 | 47.98 | 47.98 | 16.96 | 42.18 | 40.35 | 52.33 | 47.98 |
| Half-value width (μm) | 51.96 | 30.86 | 25.23 | 12.99 | 68.70 | 36.07 | 72.44 | 42.89 |
| Sensory evaluation | 2 | 4 | 1 | 1 | 1 | 1 | 1 | 4 |

| | | | Co. | | | | |
|---|---|---|---|---|---|---|---|
| | | Ex. | Ex. | Ex. | Ex. | Ex. | Ex. |
| Raw material | | 4 | 6 | 5 | 6 | 7 | 8 |
| Oil | Rapeseed | 45 | 45 | 31 | 31 | 13 | 13 |
| phase | oil | | | | | | |
| | Sesame | 2 | 2 | 4 | 4 | 6 | 6 |
| | oil | | | | | | |
| | Sesame | 0 | 0 | 0 | 0 | 0 | 0 |
| | flavoring | | | | | | |
| | agent | | | | | | |
| Aqueous | Edible | 13 | 13 | 13 | 13 | 13 | 13 |
| phase | vinegar | | | | | | |
| | Soy | 4 | 4 | 4 | 4 | 4 | 4 |
| | sauce | | | | | | |
| | Xanthane | 0.25 | 0.25 | 0.15 | 0.15 | 0.15 | 0.15 |
| | gum | | | | | | |
| | Common | 3 | 3 | 3 | 3 | 3 | 3 |
| | salt | | | | | | |
| | Granulated | 15 | 15 | 15 | 15 | 15 | 15 |
| | sugar | | | | | | |
| | Roasted | 3 | 3 | 3 | 3 | 3 | 3 |
| | black | | | | | | |
| | sesame | | | | | | |
| | seeds | | | | | | |
| | (dry | | | | | | |
| | weight) | | | | | | |
| | Ground | 6.5 | 6.5 | 13 | 13 | 9 | 9 |
| | black | | | | | | |
| | sesame | | | | | | |
| | seeds | | | | | | |
| | (dry | | | | | | |
| | weight) | | | | | | |
| | Modified | 0 | 0 | 0 | 0 | 0 | 0 |
| | starch | | | | | | |
| | (octenyl | | | | | | |
| | succinic | | | | | | |
| | acid | | | | | | |
| | starch | | | | | | |
| | sodium) | | | | | | |
| | Egg | 0 | 0 | 0 | 0 | 0 | 0 |
| | yolk | | | | | | |
| | Fresh- | Bal- | Bal- | Bal- | Bal- | Bal- | Bal- |
| | water | ance | ance | ance | ance | ance | ance |

| | | | | | | |
|---|---|---|---|---|---|---|
| Total (% by mass) | 100 | 100 | 100 | 100 | 100 | 100 |
| Content of acetic acid | 0.52 | 0.52 | 0.52 | 0.52 | 0.52 | 0.52 |
| (% by mass) | | | | | | |
| Content of edible oil | 47 | 47 | 35 | 35 | 19 | 19 |
| and fat (% by mass) | | | | | | |
| Viscosity (mPa · s) | 13200 | 13000 | 6500 | 6600 | 1700 | 1800 |
| Mode size (μm) | 67.86 | 67.86 | 57.06 | 42.18 | 52.33 | 44.00 |
| Half-value width (μm) | 56.72 | 60.70 | 47,65 | 33.70 | 49.59 | 36.75 |
| Sensory evaluation | 3 | 1 | 4 | 4 | 3 | 4 |

TABLE 3

| | | | Co. | Co. | Co. | Co. | Co. | | | | | Co. |
|---|---|---|---|---|---|---|---|---|---|---|---|---|
| | | Ex. | Ex. | Ex. | Ex. | Ex. | Ex. | Ex. | Ex. | Ex. | Ex. | Ex. |
| Raw material | | 9 | 7 | 8 | 9 | 10 | 11 | 10 | 11 | 12 | 13 | 12 |
| Oil | Rapeseed | 25 | 25 | 13 | 13 | 13 | 13 | 38 | 38 | 25 | 25 | 10 |
| | oil | | | | | | | | | | | |
| phase | Sesame | 3 | 3 | 1 | 1 | 0.5 | 0.5 | 0 | 0 | 0 | 0 | 1 |
| | oil | | | | | | | | | | | |
| | Sesame | 0.3 | 0.3 | 0 | 0 | 0 | 0 | 1.7 | 1.7 | 0.05 | 0.05 | 0 |
| | flavoring | | | | | | | | | | | |
| | agent | | | | | | | | | | | |
| Aqueous | Edible | 19 | 19 | 30 | 30 | 4 | 4 | 16 | 16 | 10 | 10 | 13 |
| | vinegar | | | | | | | | | | | |
| phase | Soy | 4 | 4 | 4 | 4 | 4 | 4 | 4 | 4 | 4 | 4 | 4 |
| | sauce | | | | | | | | | | | |
| | Xanthane | 0.15 | 0.15 | 0.35 | 0.35 | 0.35 | 0.35 | 0.25 | 0.25 | 0.20 | 0.20 | 0.45 |
| | gum | | | | | | | | | | | |
| | Common | 3 | 3 | 3 | 3 | 3 | 3 | 3 | 3 | 3 | 3 | 3 |
| | salt | | | | | | | | | | | |
| | Granulated | 20 | 20 | 15 | 15 | 15 | 15 | 17 | 17 | 4 | 4 | 1 |
| | sugar | | | | | | | | | | | |
| | Roasted | 4 | 4 | 3 | 3 | 3 | 3 | 6 | 6 | 2 | 2 | 2 |
| | black | | | | | | | | | | | |
| | sesame | | | | | | | | | | | |
| | seeds | | | | | | | | | | | |
| | (dry | | | | | | | | | | | |
| | weight) | | | | | | | | | | | |
| | Ground | 8 | 8 | 6.5 | 6.5 | 6.5 | 6.5 | 2 | 2 | 11 | 11 | 1 |
| | black | | | | | | | | | | | |
| | sesame | | | | | | | | | | | |
| | seeds | | | | | | | | | | | |
| | (dry | | | | | | | | | | | |
| | weight) | | | | | | | | | | | |
| | Modified | 0 | 0 | 0 | 0 | 0 | 0 | 0 | 0 | 0 | 0 | 0 |
| | starch | | | | | | | | | | | |
| | (octenyl | | | | | | | | | | | |
| | succinic | | | | | | | | | | | |
| | acid | | | | | | | | | | | |
| | starch | | | | | | | | | | | |
| | sodium) | | | | | | | | | | | |
| | Egg | 0 | 0 | 0 | 0 | 0 | 0 | 0 | 0 | 0 | 0 | 0 |
| | yolk | | | | | | | | | | | |
| | Fresh- | Bal- | Bal- | Bal- | Bal- | Bal- | Bal- | Bal- | Bal- | Bal- | Bal- | Bal- |
| | water | ance | ance | ance | ance | ance | ance | ance | ance | ance | ance | ance |

| | | | | | | | | | | | |
|---|---|---|---|---|---|---|---|---|---|---|---|
| Total (% by mass) | 100 | 100 | 100 | 100 | 100 | 100 | 100 | 100 | 100 | 100 | 100 |
| Content of acetic acid | 0.76 | 0.76 | 1.2 | 1.2 | 0.16 | 0.16 | 0.64 | 0.64 | 0.40 | 0.40 | 0.52 |
| (% by mass) | | | | | | | | | | | |
| Content of edible oil and fat | 28.3 | 28.3 | 14 | 14 | 13.5 | 13.5 | 39.7 | 39.7 | 25.05 | 25.05 | 11 |
| (% by mass) | | | | | | | | | | | |
| Viscosity (mPa · s) | 3900 | 3900 | 3600 | 3800 | 3550 | 3700 | 7400 | 7100 | 2700 | 3100 | 2700 |
| Mode size (μm) | 52.33 | 40.35 | 47.98 | 40.35 | 52.33 | 40.35 | 74.00 | 74.00 | 52.33 | 47.98 | 67.86 |
| Half-value width (μm) | 43.70 | 28.53 | 33.93 | 36.07 | 40.07 | 36.07 | 56.72 | 52.37 | 37.00 | 33.93 | 60.70 |
| Sensory evaluation | 4 | 1 | 1 | 1 | 1 | 1 | 3 | 3 | 4 | 4 | 1 |

### Production Example 2 of Acidic Liquid Seasoning

### Example 14

An acidic liquid seasoning was produced according to a compounding proportion described in Table 4. Specifically, edible vinegar (content of acetic acid 4%), xanthane gum, common salt, granulated sugar, a dry onion ingredient, a grated onion ingredient, sodium glutamate, and freshwater were loaded to a stirring tank and homogeneously mixed, and thus an aqueous phase was prepared. Thereafter, edible oil and fat (rapeseed oil and olive oil) serving as an oil phase were injected to the aqueous phase prepared, an emulsification treatment was performed under stirring, and thus an acidic liquid seasoning having an emulsified phase was produced. Subsequently, a package was filled with the acidic liquid seasoning obtained, and thus a packaged acidic liquid seasoning was obtained.

### Examples 15 to 17 and Comparative Examples 13 to 14

Each acidic liquid seasoning having an emulsified phase was produced in the same manner as in Example 14 except that the compounding proportion was changed as described in Table 4 and the intensity of stirring in the emulsification treatment was appropriately changed.

### (Measurement of pH)

The pH of each of the acidic liquid seasonings of Examples 14 to 17, obtained above, was measured in the same manner as in <Production Example 1 of acidic liquid seasoning>described above. The pH of each of the acidic liquid seasonings was 3.6 or more and 4.3 or less.

### (Measurement of Brix)

The brix of the aqueous phase of each of the acidic liquid seasonings of Examples 14 to 17, obtained above, was measured in the same manner as in <Production Example 1 of acidic liquid seasoning>described above. The brix of the aqueous phase of each of the acidic liquid seasonings was 10% or more. The total value of the content of the edible oil and fat (% by mass, based on the total amount of each of the acidic liquid seasonings) and the brix of the aqueous phase was 25 or more.

### (Measurement of Viscosity)

The viscosity of each of the acidic liquid seasonings obtained above was measured in the same manner as in <Production Example 1 of acidic liquid seasoning>described above. The measurement results were shown in Table 4.

### (Measurement of Particle Size Distribution on Volume Basis)

The particle size distribution on a volume basis of each of the acidic liquid seasonings obtained above was measured and the mode size and the half-value width were calculated in the same manner as in <Production Example 1 of acidic liquid seasoning>described above. The measurement results were shown in Table 4.

### (Sensory Evaluation)

Each of the acidic liquid seasonings obtained above was subjected to sensory evaluation in the same manner as in <Production Example 1 of acidic liquid seasoning>described above. The results were shown in Table 4. A score of 2 points or more can be said to mean a favorable result.

In each of the acidic liquid seasonings of Examples 14 to 17, a sour taste with the aqueous phase and a delicious taste with the oil phase were well balanced and these tastes were well differentiated.

In each of the acidic liquid seasonings of Comparative Examples 13 and 14, the half-value width of the mode size of oil droplets in the emulsified phase was large, thus a delicious taste with the oil phase was not felt and the balance was inferior, and a sour taste with the aqueous phase and a delicious taste with the oil phase were not differentiated.

TABLE 4

| | | Comparative | | | | Comparative | |
|---|---|---|---|---|---|---|---|
| Raw material | | Example 13 | Example 14 | Example 15 | Example 16 | Example 14 | Example 17 |
| Oil | Rapeseed | 30 | 30 | 30 | 30 | 15 | 15 |
| phase | oil | | | | | | |
| | Olive | 10 | 10 | 0 | 0 | 7 | 7 |
| | oil | | | | | | |
| | Lemon | 0 | 0 | 0.3 | 0.3 | 0 | 0 |
| | flavoring | | | | | | |
| | agent | | | | | | |
| Aqueous | Edible | 16 | 16 | 19 | 19 | 11 | 11 |
| phase | vinegar | | | | | | |
| | Xanthane | 0.25 | 0.25 | 0.35 | 0.35 | 0.40 | 0.40 |
| | gum | | | | | | |
| | Common | 2.6 | 2.6 | 2.7 | 2.7 | 2.4 | 2.4 |
| | salt | | | | | | |
| | Granulated | 10 | 10 | 7 | 7 | 4 | 4 |
| | sugar | | | | | | |
| | Dry | 1 | 1 | 1 | 1 | 1 | 1 |
| | onion | | | | | | |
| | ingredient | | | | | | |
| | (dry | | | | | | |
| | weight) | | | | | | |
| | Grated | 1.3 | 1.3 | 1.5 | 1.5 | 0.8 | 0.8 |
| | onion | | | | | | |
| | (dry | | | | | | |
| | weight) | | | | | | |
| | Sodium | 0.5 | 0.5 | 0.5 | 0.5 | 0.5 | 0.5 |
| | glutamate | | | | | | |
| | Fresh- | Bal- | Bal- | Bal- | Bal- | Bal- | Bal- |
| | water | ance | ance | ance | ance | ance | ance |

| | | | | | | |
|---|---|---|---|---|---|---|
| Total (% by mass) | 100 | 100 | 100 | 100 | 100 | 100 |
| Content of acetic acid | 0.64 | 0.64 | 0.76 | 0.76 | 0.44 | 0.44 |
| (% by mass) | | | | | | |
| Content of edible oil and fat | 40 | 40 | 30.3 | 30.3 | 22 | 22 |
| (% by mass) | | | | | | |
| Viscosity (mPa · s) | 4600 | 4300 | 4500 | 4200 | 3500 | 3400 |
| Mode size(μm) | 74.00 | 67.86 | 67,86 | 62.23 | 74.00 | 62.23 |
| Half-value width (μm) | 61.77 | 43.63 | 47.98 | 44.00 | 61.77 | 51.96 |
| Sensory evaluation | 1 | 4 | 3 | 4 | 1 | 4 |

1. A packaged acidic liquid seasoning containing at least edible oil and fat, edible vinegar, a plant ground product, thickening polysaccharide, and water, and at least partially having an emulsified phase, wherein
a content of egg yolk is 0% by mass or more and 0.001% by mass or less,
the edible oil and fat contain flavor oil and/or an oil-soluble flavoring agent,
a content of the edible oil and fat is 15% by mass or more and 50% by mass or less based on the total amount of the acidic liquid seasoning,
a content of acetic acid is 0.3% by mass or more and 0.8% by mass or less based on the total amount of the acidic liquid seasoning,
a viscosity of the acidic liquid seasoning at 25° C. is 1500 mPa·s or more, and
a half-value width of a mode size of oil droplets in the emulsified phase of the acidic liquid seasoning is 30.0 μm or more and 60.0 μm or less in a particle size distribution on a volume basis measured with a laser diffraction type particle size distribution measuring apparatus in analysis conditions: non-sphericity and refractive index 1.6, particle size measurement range: 0.021 μm or more and 2000 μm or less, and particle size scale: 132 ch.

2. The acidic liquid seasoning according to claim 1, wherein the mode size of oil droplets in the emulsified phase of the acidic liquid seasoning is 20 μm or more and 100 μm or less.

3. The acidic liquid seasoning according to claim 1, wherein the viscosity of the acidic liquid seasoning at 25° C. is 20000 mPa·s or less.

4. The acidic liquid seasoning according to claim 1, wherein a content of the plant ground product in terms of dry weight is 0.1% by mass or more and 40% by mass or less based on the total amount of the acidic liquid seasoning.

5. The acidic liquid seasoning according to claim 1, wherein the thickening polysaccharide is gum.

6. The acidic liquid seasoning according to claim 5, wherein a content of the gum is 0.01% by mass or more and 1.0% by mass or less based on the total amount of the acidic liquid seasoning.

7. The acidic liquid seasoning according to claim 5, wherein the gum comprises at least one or more selected from the group consisting of xanthane gum, guar gum, tamarind seed gum, locust bean gum, gellan gum, and arabic gum.

8. The acidic liquid seasoning according to claim 5, wherein the gum comprises xanthane gum.

9. The acidic liquid seasoning according to claim 8, wherein a content of the xanthane gum is 0.01% by mass or more and 1.0% by mass or less based on the total amount of the acidic liquid seasoning.

10. The acidic liquid seasoning according to claim 1, wherein a plant material in the plant ground product comprises sesame seeds.

11. The acidic liquid seasoning according to claim 1, wherein a plant material in the plant ground product comprises an onion.

12. The acidic liquid seasoning according to claim 1, wherein the acidic liquid seasoning further contains a plant ingredient.

13. The acidic liquid seasoning according to claim 12, wherein the plant ingredient is the same plant material as that in the plant ground product.
